(19) United States
(12) Patent Application Publication
(10) Pub. No.: US 2019/0196094 A1
(43) Pub. Date: Jun. 27, 2019

(54) LIGHTING DEVICE AND DISPLAY DEVICE

(71) Applicant: SHARP KABUSHIKI KAISHA, Sakai City, Osaka (JP)

(72) Inventor: QINGLE XU, Sakai City (JP)

(21) Appl. No.: 16/331,897

(22) PCT Filed: Sep. 6, 2017
(86) PCT No.: PCT/JP2017/032034

§ 371 Date: Mar. 8, 2019

(30) Foreign Application Priority Data
Sep. 13, 2016 (JP) 2016-178560

(51) Int. Cl. F21V 8/00

(52) U.S. Cl. CPC G02B 6/0091; G02B 6/0033; G02B 6/0013; G02B 6/0083

(57) ABSTRACT

A lighting device includes an LED, an LED board having a mount surface on which the LED is mounted with a mounted surface of the LED being in contact with the mount surface, and a light guide plate having a light input surface that receives light from the LED, a light-exit surface through which the light exits, and a light-exit opposite surface. The LED board includes an LED overlapping portion overlapping the LED and an extension portion extending from the LED overlapping portion in a direction in which a light emitting surface faces. The light guide plate is integrated with the LED and the LED board with the light input surface being in direct contact with the light emitting surface of the LED and the light-exit surface or the light-exit opposite surface being in direct contact with the mount surface of the extension portion.

### TECHNICAL FIELD

The present invention relates to a lighting device and a display device.

### BACKGROUND ART

One example of a known surface-emitting device mounted in a liquid crystal display device is described in Patent Document 1. In the production of the surface-emitting device in Patent Document 1, a board unit is inserted when an acrylic light guide plate is formed by injection molding. The board unit includes a board having a circuit on an upper surface thereof and LEDs, which are point light sources connected to the upper surface. The board unit is inserted such that the lower surface is exposed. The board unit is integrated with the light guide plate at portions other than the exposed portion.

### RELATED ART DOCUMENT

### Patent Document

Patent Document 1: Japanese Unexamined Patent Application Publication No. 2001-143517

### Problem to be Solved by the Invention

In the surface-emitting device in Patent Document 1, a large portion of the board on which the LEDs are mounted is in the light guide plate. This makes the shape of a portion of the light guide plate near the light sources complex. The complex shape may reduce the amount of outgoing light from the light guide plate. Furthermore, the thickness of the light guide plate increases by the thickness of the board in the light guide plate, making the optical path of the light traveling through the light guide plate longer. The longer optical path results in an increase in the amount of light absorbed by the light guide plate, leading to a reduction in the amount of outgoing light from the light guide plate.

### DISCLOSURE OF THE PRESENT INVENTION

The present invention was made in view of the above circumstances. An object is to improve the brightness.

### Means for Solving the Problem

A lighting device according to the present invention includes a light source having a light emitting surface, a light source board having a mount surface on which the light source is mounted with one of outer surfaces of the light source that is adjacent to the light emitting surface being in contact with the mount surface, and a light guide plate in which at least a portion of an outer end surface thereof is a light input surface that receives light from the light source, one of two plate surfaces thereof is a light-exit surface through which the light exits, and the other of the plate surfaces is a light-exit opposite surface. The light source board at least includes a light-source overlapping portion overlapping the light source and an extension portion extending from the light-source overlapping portion in a direction in which the light emitting surface faces. The light guide plate is integrated with the light source and the light source board with the light input surface being in direct contact with the light emitting surface of the light source and the light-exit surface or the light-exit opposite surface being in direct contact with the mount surface of the extension portion.

In this configuration, outgoing light from the light emitting surface of the light source enters the light guide plate through the light input surface and the light that has traveled in the light guide plate exits through the light-exit surface. Since the light guide plate is in direct contact with the light emitting surface of the light source at the light input surface, input efficiency of light to the light input surface is high. Furthermore, since the light guide plate is integrated with the light source and the light source board while being in direct contact with the light emitting surface of the light source, the positional relationship between the light input surface and the light emitting surface of the light source is unlikely to change when the light guide plate is thermally expanded or contracted due to a change in temperature. This configuration advantageously allows the light input efficiency to remain high.

Furthermore, since the light guide plate is integrated with the light source and the light guide board with the light-exit opposite surface thereof being in direct contact with the mount surface of the extension portion, which is a portion of the light source board extending from the light-source overlapping portion in a direction in which the light emitting surface faces, the light source board is not located in the light guide plate. This does not make the shape of the portion of the light guide plate near the light source complex and allows light to efficiently travel through the light guide plate. Furthermore, the light guide plate is thin compared to the known light guide plate having the light source board therein. This makes the optical length of light traveling through the light guide plate shorter, reducing the amount of light absorbed by the light guide plate. With this configuration, the amount of outgoing light from the light guide plate through the light-exit surface increases and the brightness of the outgoing light improves.

The following configurations are preferable embodiments of the invention.

(1) The light guide plate may be selectively in direct contact with the light emitting surface. The light emitting surface is one of the outer surfaces of the light source. In this configuration, the light source is in contact with the light guide plate only at the light emitting surface, which is one of outer surfaces of the light source, and thus heat generated by the light source is less likely to be transferred to the light guide plate.

(2) One of the light-exit surface and the light-exit opposite surface of the light guide plate that is opposite the surface in contact with the extension portion is flush with an outer surface of the light source opposite the outer surface in contact with the light source board. This configuration allows the input efficiency of light to the light input surface to remain high and allows the thickness of the light source to decrease up to the thickness of the light guide plate. Furthermore, in this configuration, the center of the light source in the height direction matches the center of the light guide plate in the thickness direction. This makes the input efficiency of light to the light input surface very high.

(3) The light source board includes a circuit formation portion extending from the light-source overlapping portion toward a side away from the extension portion and having a circuit for applying current to the light source. In this configuration, the circuit formation portion, which extends from the light-source overlapping portion toward a side away from the extension portion, does not overlap the light guide plate. With this configuration, when the circuit is heated due to application of current to the light source, the heat is less likely to be transferred to the light guide plate.

Next, to solve the above-described problems, a display device according to the present invention includes the above-described lighting device and a display panel configured to display an image by using light from the lighting device. The display device having such a configuration has improved display quality and lower power consumption, because outgoing light from the lighting device has improved brightness.

### Advantageous Effect of the Invention

According to the present invention, brightness is improved.

### BRIEF DESCRIPTION OF THE DRAWINGS

FIG. 1 is an exploded perspective view illustrating a schematic configuration of a liquid crystal display device according to a first embodiment of the invention.

FIG. 2 is a cross-sectional view illustrating a cross-sectional configuration of the liquid crystal display device taken in a short-side direction.

FIG. 3 is a plan view of LEDs, an LED board, and a light guide plate.

FIG. 4 is a cross-sectional side view illustrating the LEDs and the LED board set in a molding die for molding the light guide plate from resin.

FIG. 5 is a cross-sectional view taken along line A-A in FIG. 4.

FIG. 6 is a cross-sectional view illustrating a liquid crystal display device according to a second embodiment of the present invention taken in a short-side direction.

FIG. 7 is a cross-sectional side view illustrating LEDs, an LED board, and a light guide plate according to a third embodiment of the present invention.

### MODE FOR CARRYING OUT THE INVENTION

### First Embodiment

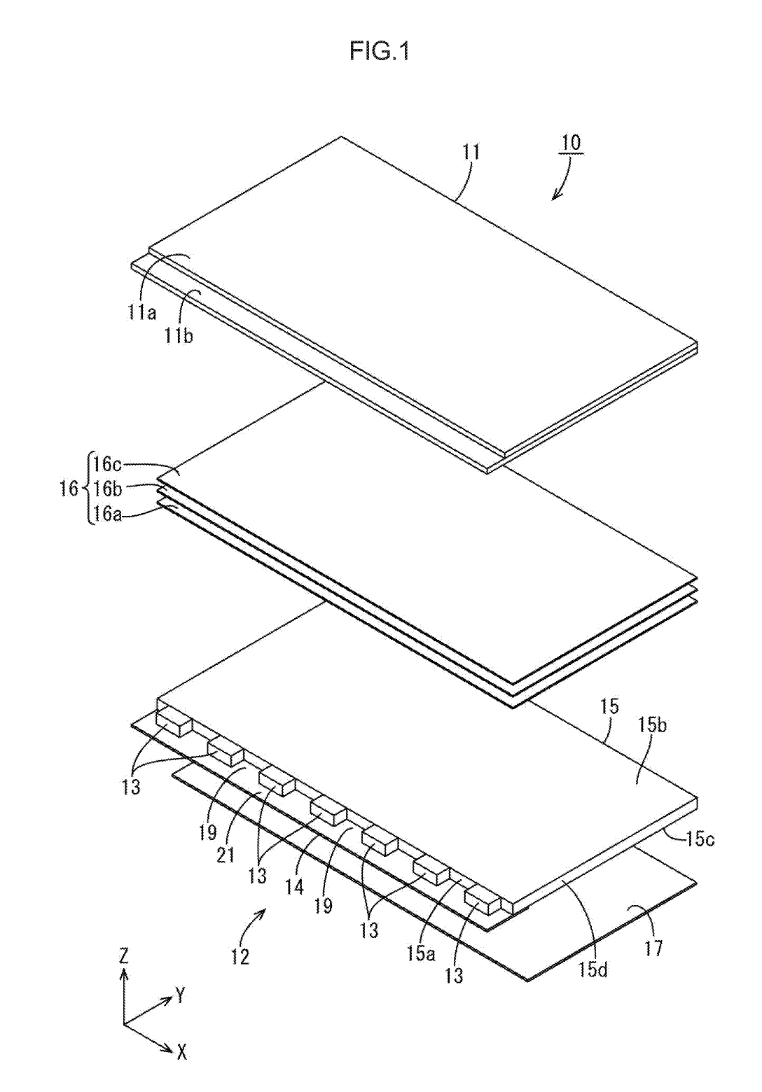

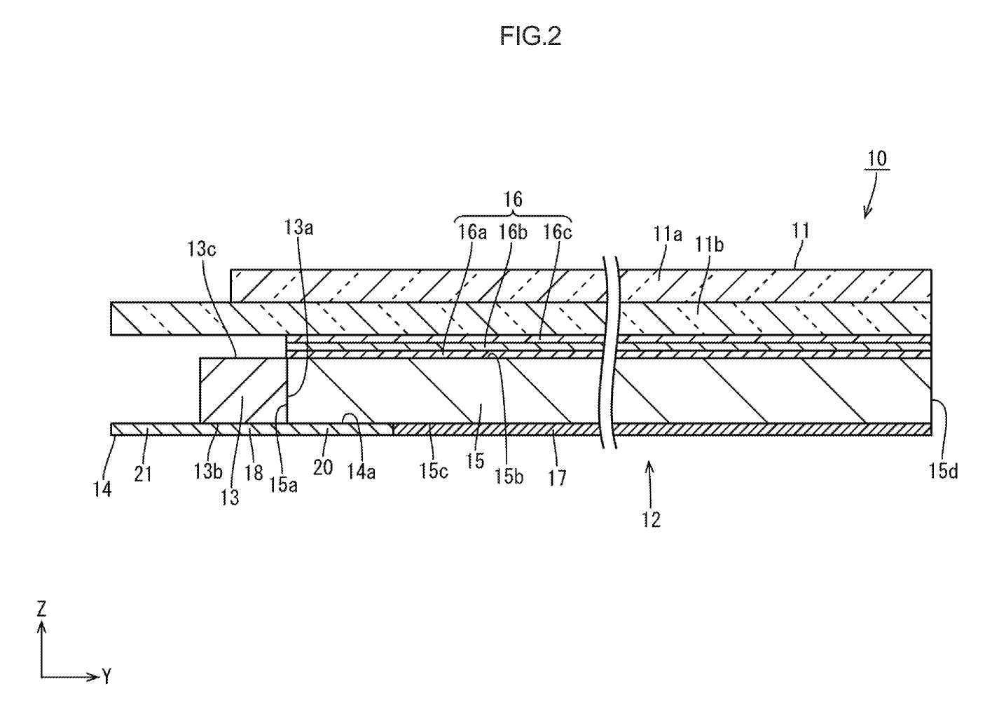

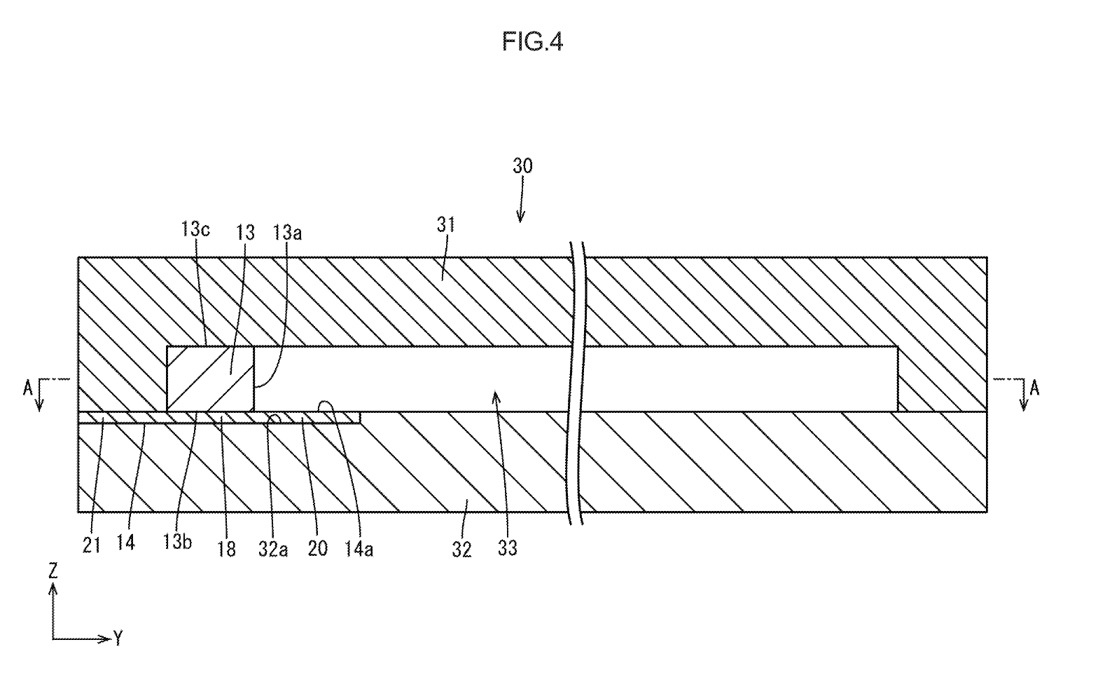

A first embodiment of the invention is described with reference to FIGS. 1 to 5. In this embodiment, a liquid crystal display device (display device) 10 is described as an example. The X, Y, and Z axes are indicated in some of the drawings, and each of the axes indicates the same direction in the respective drawings. The upper side in FIGS. 2 and 4 is a front side and the lower side in those figures is a rear side.

As illustrated in FIG. 1, the liquid crystal display device 10 according to the embodiment has a horizontally-long (longitudinal) oblong (rectangular) overall shape and includes a liquid crystal panel (display panel) 11 configured to display an image and a backlight device (lighting device) 12 that is an external light source configured to supply light for displaying to the liquid crystal panel 11. The liquid crystal panel 11 and the backlight device 12 are held together by a frame-shaped bezel, which is not illustrated, for example. The liquid crystal display device 10 according to the embodiment is preferably used in a mobile information terminal such as a tablet notebook computer or an in-vehicle device such as a car navigation system. The liquid crystal panel 11 has a screen size of about a few inches to about a dozen inches, which is categorized as a small size or a small to medium size in general.

Next, the liquid crystal panel 11 and the backlight device 12 included in the liquid crystal display device 10 will be described sequentially. As illustrated in FIG. 1, the liquid crystal panel (display panel) 11 has a horizontally-long oblong shape in plan view and includes two glass substrates 11a and 11b bonded together with a predetermined gap therebetween and a liquid crystal layer (not illustrated) sealed between the substrates 11a and 11b. The liquid crystal layer includes liquid crystal molecules, which are substances whose optical properties are changed by application of an electrical field. On an inner surface of one of the glass substrates (array substrate, active matrix substrate) 11b, switching devices (for example, TFTs), which are connected to source lines and gate lines positioned perpendicular to each other, and pixel electrodes, which are disposed in a rectangular area defined by the source lines and the gate lines and connected to the switching devices, are planarly arranged in a matrix, and also an alignment film, for example, is disposed. On an inner surface of the other glass substrate (counter substrate, CF substrate) 11a, a color filter including coloring portions, such as R (red), G (green), and B (blue) coloring portions are planarly arranged in a matrix in a predetermined arrangement, and also a grid-shaped light blocking layer (black matrix) positioned between the respective coloring portions, a planar counter electrode facing the pixel electrodes, and an alignment film, for example, are disposed. A polarizing plate, which is not illustrated, is disposed on an outer surface of each glass substrate 11a and 11b. The long-side direction, the short-side direction, and the thickness direction of the liquid crystal panel 11 respectively match the X-axis direction, the Y-axis direction, and the Z-axis direction.

As illustrated in FIG. 1, the backlight device 12 at least includes LEDs 13, which are light sources, an LED board 14 on which the LEDs 13 are disposed, a light guide plate 15 which guides the light from the LEDs 13, an optical sheet 16 disposed on a front surface of the light guide plate 15 (adjacent to the liquid crystal panel 11, light exiting side), and a reflection sheet (reflector) 17 disposed on a rear surface of the light guide plate 15. The LED board 14 is located at one of end portions of the backlight device 12 along a long side, and thus the LEDs 13 on the LED board 14 are only located relative to only one end portion of the liquid crystal panel 11 along the long side. As can be seen from this, the backlight device 12 according to the embodiment is an edge-lit (side-lit) backlight device in which light from the LEDs 13 enters the light guide plate 15 through only one side thereof. Next, components of the backlight device 12 will be descried in detail.

As illustrated in FIGS. 1 and 2, the LED 13 has a block-like overall shape and one of outer surfaces thereof is a light-emitting surface 13a that emits light. An outer surface of the LED 13 that is adjacent to the light-emitting surface 13a is a mounted surface 13b in contact with the LED board 14. The LED 13 is a side-lit LED. In other words, in the side-lit LED 13, a surface (side surface) lateral to the mounted surface 13b, which is in contact with the LED board 14, is the light-emitting surface 13a. The light-emitting surface 13a of the LED 13 is a substantially flat surface extending in the X-axis and Z-axis directions and faces the right side in FIG. 2 in the Y-axis direction. The light from the light-emitting surface 13a travels in a direction in which the light-emitting surface 13a faces. The optical axis of the LED 13 extends in the Y-axis direction, which is a normal direction with respect to the light-emitting surface 13a. Here, the “optical axis” is a traveling direction of light having the highest intensity from the LED 13 (light distribution). The LEDs 13 each have an LED chip that emits a single-color light such as blue light and a sealing material containing a phosphor (such as a yellow phosphor, a green phosphor, and a red phosphor) in a dispersed state, and thus the LEDs 13 emit white light as a whole.

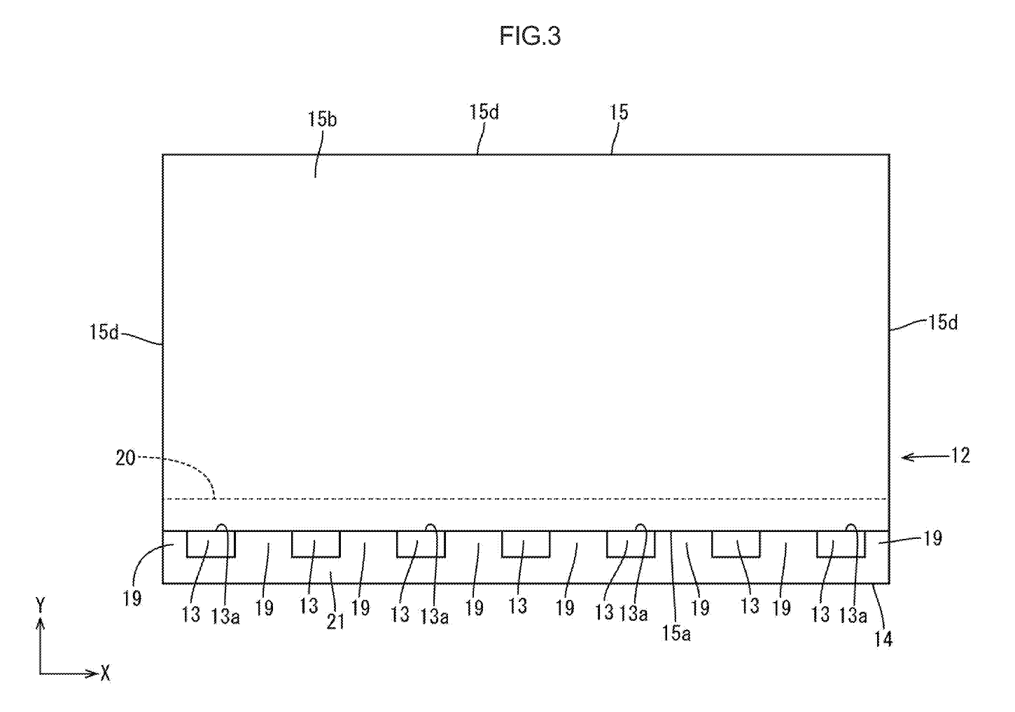

As illustrated in FIGS. 1 and 3, the LED board 14 is a flexible film (sheet) formed of an insulating material and has a thin band-like shape extending in the long-side direction of the light guide plate 15, which will be described later. The plate surfaces of the LED board 14 extend parallel to the plate surfaces of the light guide plate 15. The LED board 14 is located such that the longitudinal direction (long-side direction), the width direction (short-side direction), and the thickness direction, respectively, match the X axis direction, the Y axis direction, and the Z axis direction. The LED board 14 is in contact with the mounted surfaces 13b of the LEDs 13 at the front one of the two plate surfaces, and the front plate surface is referred to as a mount surface 14a on which the LEDs 13 are mounted. Multiple LEDs 13 (seven LEDs in FIGS. 1 and 3) are disposed with a space therebetween in the X axis direction on the LED board 14.

As illustrated in FIGS. 2 and 3, the LED board 14 includes LED overlapping portions (light-source overlapping portions, light-source mount portions) 18 having the LEDs 13 thereon and overlapping the LEDs 13 in plan view, LED non-overlapping portions 19 adjacent to the LED overlapping portions 18 in the X axis direction and not overlapping the LEDs 13 in plan view, an extension portion (light-guide-plate overlapping portion) 20 extending from the LED overlapping portions 18 and the LED non-overlapping portions 19 in the Y axis direction (normal direction with respect to the light-emitting surface 13a, direction along the optical axis) to the right side in FIG. 2 (in a direction in which the light emitting surfaces 13a of the LEDs 13 face), and a circuit formation portion 21 extending from the LED overlapping portions 18 and the LED non-overlapping portion 19 in the Y axis direction to the left side in FIG. 2 (side away from the extension portion 20) and having a circuit (not illustrated) for applying current to the LEDs 13. The multiple LED overlapping portions 19 and the multiple LED non-overlapping portions 19 are repeatedly alternately arranged in the X axis direction. The number of LED overlapping portions 18 is equal to the number of LEDs 13. The number of LED non-overlapping portions 19 is one more than the number of LEDs 13. The extension portion 20 is disposed on the rear surface of the light guide plate 15 (side away from the light exit side). On the mount surface 14a of the circuit formation portion 21, a circuit for applying current to the LEDs 13 is disposed. The circuit at least includes a wiring pattern connected in parallel with the LEDs 13 and circuit components such as a constant-current diode and a resistor (both of the wiring pattern and the circuit element are not illustrated). The circuit components are separately connected in series with the LEDs 13 to equalize the amount of light emitted by the parallel-connected LEDs 13. The LED non-overlapping portions IS and the circuit formation portion 21 do not overlap the LEDs 13 and the light guide plate 15 in plan view.

The light guide plate 15 is formed of a substantially transparent synthetic resin material having a refractive index sufficiently higher than that of air. As illustrated in FIGS. 1 and 2, the light guide plate 15 is located directly below the liquid crystal panel 11 and the optical sheet 16 and the plate surfaces thereof are parallel to the plate surfaces of the liquid crystal panel 11 and the optical sheet 16. The light guide plate 15 is a plate having a thickness larger than that of the optical sheet 16 and has a horizontally-long oblong shape in plan view. The light guide plate 15 include two outer end surfaces along the long sides and two outer end surfaces along the short sides, which are perpendicular to each other. One of the outer end surfaces of the light guide plate 15 that is along the left long side in FIG. 2 is a light input surface (light-source opposing end surface) 15a that faces the LEDs 13 and directly receives light from the LEDs 13. The remaining three end surfaces (the end surface along the other long side and the two end surfaces along the short sides) are non-light input surfaces (light-source non-opposing surfaces) 15d that do not face the LEDs 13 and not directly receive light from the LEDs 13. The light input surface 15a extends parallel to the light-emitting surfaces 13a of the LEDs 13 in the X axis direction (direction in which the LEDs 13 are arranged). One of the plate surfaces of the light guide plate 15 that faces the front side (the liquid crystal panel 11, the optical sheet 16) is a light-exit surface 15b through which light is output toward the liquid crystal panel 11 and the optical sheet 16. One of the plate surfaces that faces the rear side is a light-exit opposite surface 15c opposite the light-exit surface 15b. The light guide plate 15 having such a configuration receives light, which has been emitted from the light-emitting surfaces 13a of the LEDs 13 in the Y-axis direction, through the light-input surface 15a and allows the light that has traveled therein to travel upward in the Z axis direction such that the light exits through the light-exit surface 15b toward the optical sheet 16 (front side, light-exit side).

As illustrated in FIGS. 1 and 2, the optical sheet 16 has a horizontally-long oblong shape in plan view as the liquid crystal panel 11. The optical sheet 16 is disposed on the light-exit surface 15b of the light guide plate 15 and is located between the liquid crystal panel 11 and the light guide plate 15. In other words, the optical sheet 16 is located adjacent to the exit of the light pathway extending from the LEDs 13. The optical sheet 16 is a component (optical component) that exerts predetermined optical effects on the light emitted by the LEDs 13 and allows the light to travel toward the liquid crystal panel 11. Specifically described, the optical sheet 16 according to the embodiment includes three sheets: a microlens sheet 16a that exerts isotropic light collecting effect on the light, a prism sheet 16b that exerts anisotropic light collecting effect on the light, and reflective polarizing sheet 16c that polarizes and reflects the light. The optical sheet 16 includes the microlens sheet 16a, the prism sheet 16b, end the reflective polarizing sheet 16c, in this order from the rear side.

As illustrated in FIGS. 1 and 2, the reflection sheet 17 has plate surfaces parallel to the plate surfaces of the LED board 14 and the light guide plate 15 and covers the light-exit opposite surface 15c of the light guide plate 15 from the rear side. The reflection sheet 17 has high reflectance and efficiently reflects the light that has leaked out through the light-exit opposite surface 15c of the light guide plate 15 toward the front side (light-exit surface 15b).

As illustrated in FIG. 2, the light guide plate 15 according to the embodiment is integrated with the LEDs 13 and the LED board 14 with the light input surface 15a being in direct contact with the light-emitting surfaces 13a of the LEDs 13 and with the light-exit opposite surface 15c being in direct contact with the mount surface 14a of the extension portion 20 of the LED board 14. Specifically described, the light input surface 15a of the light guide plate 15 is in direct contact with the light-emitting surfaces 13a of the LEDs 13 and fixed thereto without any other components therebetween and the light-exit opposite surface 15c is in direct contact with the mount surface 14a of the extension portion 20 and fixed thereto without any other components therebetween. Of the outer surfaces of the LED 13, the light guide plate 15 is selectively in direct contact with the light emitting surface 13a and is not in contact with the outer surfaces other than the light emitting surface 13a (including a mounted-surface opposite surface 13c, which will be described later). Similarly, of the outer surfaces of the extension portion 20 of the LED board 14, the light guide plate 15 is selectively in direct contact with the mount surface 14a and is not in contact with the outer surfaces other than the mount surface 14a. In this configuration, the LEDs 13 are not located in the light guide plate 15 and the LED board 14 is not located in the light guide plate 5, and thus the shape of the portion of the light guide plate 15 near the LEDs 13 is not made complex. As described above, the LEDs 13, the LED board 14, and the light guide plate 15 according to the embodiment are integrated (assembled, unitized) to become one non-separable component and treated as one unit. This reduces the number of components that constitute the backlight device 12, resulting in an easy parts control and reducing the number of assembling steps. Steps of integrating the LEDs 13, the LED board 14, and the light guide plate 15 include producing the LED board 14 having the LEDs 13 thereon, setting the LED board 14 in a molding die 30 for molding the light guide plate 15 from resin, and pouring a resin material into the molding die 30 to form the light guide plate 15. The specific method of producing the light guide plate 15 will be described later.

As illustrated in FIG. 2, the light guide plate 15 has a thickness substantially equal to a protrusion height (height) of the LEDs 13 protruding from the mount surface 14a of the LED board 14. Thus, the light-exit surface 15b of the light guide plate 15, which is a plate surface opposite the light-exit opposite surface 15c in contact with the extension portion 20, is flush with the mounted-surface opposite surface 13c of the LED 13, which is an outer surface opposite the mounted surface 13b in contact with the LED board 14. In other words, the light-exit opposite surface 15c of the light guide plate 15 is flush with the mounted surface 13b of the LED 13 and the light-exit surface 15b thereof is flush with the mounted-surface opposite surface 13c of the LED 13. With this configuration, the light input surface 15a of the light guide plate 15 faces the entire area of the light-emitting surfaces 13a of the LEDs 13, allowing the light input efficiency to remain high and reducing the thickness of the LED 13 up to the thickness of the light guide plate 15. In this configuration, the center of the LED 13 in the height direction (Z axis direction) matches the center of the light guide plate 15 in the thickness direction. The extension portion 20 of the LED board 14 is disposed on the rear surface (the same side as the reflection sheet 17) of the light guide plate 15 over an end portion adjacent to the LEDs 13 (light source side end portion), which includes the light input surface 15a, and is in contact with the reflection sheet 17 at the leading end portion. When the reflection sheet 17 is attached to the light guide plate 15, the reflection sheet 17 is brought into contact with the extension portion 20, which is integrated with the light guide plate 15, to positionally fix the reflection sheet 17 in the Y axis direction. There is no space between the extension portion 20 and the reflection sheet 17, which are in contact with each other, reducing the possibility that the light in the light guide plate 15 will leak out through the light-exit opposite surface 15c toward the rear side.

The embodiment has the above-described configuration, and effects obtained by the configuration will be described. When the liquid crystal display device 10 having the above-described configuration is turned on, driving of the liquid crystal panel 11 is controlled by a control circuit, which is not illustrated, and driving of the LEDs 13 on the LED board 14 is controlled by driving power supplied from an LED driving circuit, which is not illustrated, to the LEDs 13. As illustrated in FIG. 2, light from the LEDs 13 is guided by the light guide plate 15 to the liquid crystal panel 11 through the optical sheet 16, and thus a predetermined image is displayed on the liquid crystal panel 11.

Specifically described, as illustrated in FIG. 2, when the LEDs 13 are turned on, light from the light emitting surfaces 13a of the LEDs 13 enters the light guide plate 15 through the light input surface 15a and then travels through the light guide plate 15 by being totally reflected at an interface between the light guide plate 15 and an outside air layer or being reflected by the reflection sheet 17. Then, the light exits the light guide plate 15 through the light-exit surface 15b toward the optical sheet 16. Here, the input efficiency of light to the light input surface 15a is high, because the light input surface 15a of the light guide plate 15 is in direct contact with the light-emitting surfaces 13a of the LEDs 13 without any other components therebetween. Furthermore, the light-exit surface 15b of the light guide plate 15, which is a surface opposite the light-exit opposite surface 15c in contact with the extension portion 20 of the LED board 14, is flush with the mounted-surface opposite surface 13c of the LED 13, which is a surface opposite the mounted surface 13b in contact with the LED board 14. This configuration not only allows the input efficiency of the light to the light input surface 15a to remain high and the thickness of the LED 13 to decrease up to the thickness of the light guide plate 15, but also allows the center of the LEDs 13 in the height direction to match the center of the light guide plate 15 in the thickness direction. This makes the input efficiency of light to the light input surface 15a very high.

In addition, as illustrated in FIG. 2, the light guide plate 15 is integrated with the LEDs 13 and the LED board 14 with the light-exit opposite surface 15c being in direct contact with the mount surface 14a of the extension portion 20, which extends from the LED overlapping portion 18 of the LED board 14 in the direction in which the light emitting surface 13a faces. In this configuration, the LEDs 13 and the LED board 11 are not located in the light guide plate 15, and thus the shape of the portion of the light guide plate 15 near the LEDs 13 is not made complex. This allows light to more efficiently travel in the light guide plate 15. Furthermore, since the light guide plate 15 has a thickness smaller than that of the known light guide plate having the LED board therein, the optical path length of the light traveling in the light guide plate 15 is shorter and the amount of light absorbed by the light guide plate 15 is smaller. This increases the amount of outgoing light from the light guide plate 15 through the light-exit surface 15b, improving brightness of the outgoing light.

When the LEDs 13 are turned on, the temperature inside the backlight device 12 increases because the circuits of the LEDs 13 and the LED board 14 are heated. Contrary to this, when the LEDs 13 are turned off, the temperature inside the backlight device 12 decreases because the circuits of the LEDs 13 and the LED board 14 are not heated. Such changes in temperature in the backlight device 12 may cause the light guide plate 15, which is a large-size component, to undergo thermal expansion or thermal contraction. However, the positional relationship between the light input surface 15a and the light emitting surfaces 13a of the LEDs 13 is unlikely to change, because the light guide plate 15 is integrated with the LEDs 13 and the LED board 14 while being in direct contact with the light emitting surfaces 13a of the LEDs 13. This configuration allows the light input efficiency to remain high. Furthermore, the light guide plate 15, which is in direct contact with the light emitting surfaces 13a of the LEDs 13, is not in contact with the surfaces of the LEDs 13 other than the light emitting surfaces 13e. In other words, the LEDs 13 are each in contact with the light guide plate 15 only at the light emitting surface 13a, which is one of the outer surfaces of the LEDs 13, and thus heat generated by the LEDs 13 is less likely to be transferred to the light guide plate 15. Furthermore, the circuit formation portion 21 of the LED board 14, which has a circuit, i.e., a heat source, extends from the LED overlapping portion 18 toward the side away from the extension portion 20 and does not overlap the light guide plate 15. With this configuration, when the circuit is heated due to application of current to the LEDs 13, the heat is less likely to be transferred to the light guide plate 15. This reduction in heat transfer to the light guide plate 15 results in a reduction in the amount of elongation and contraction of the light guide plate 15, reducing the possibility that the light guide plate 15 and another component will rub each other and make noise.

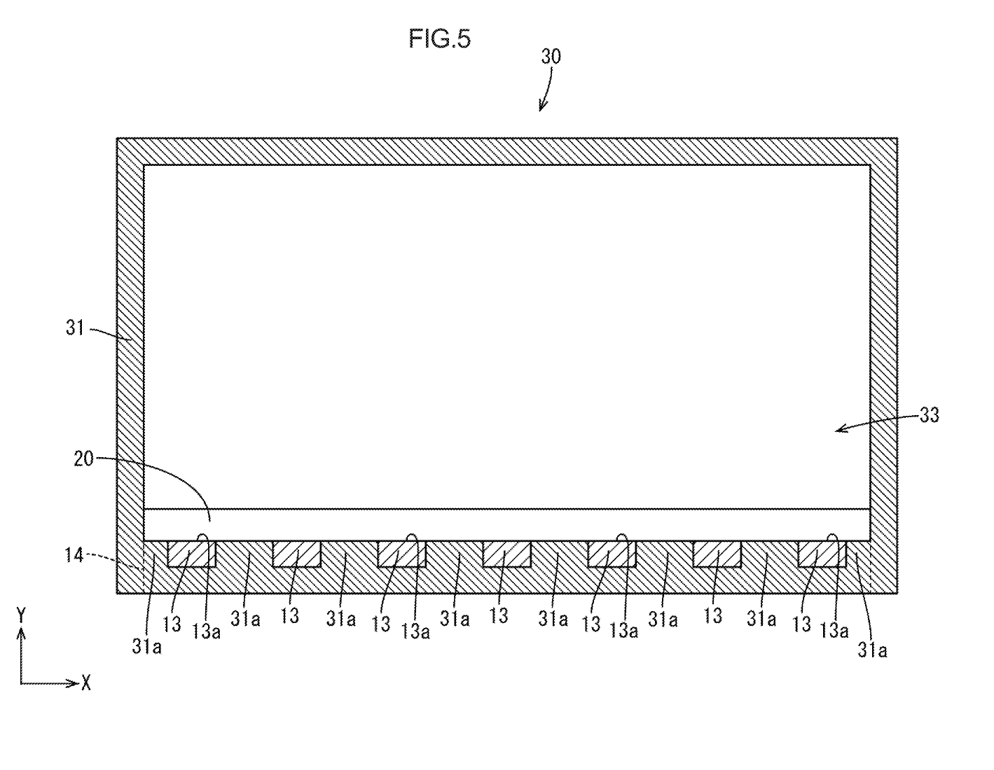

Next, a method of producing the light guide plate 15 will be described. To produce the light guide plate 15, the LED board 14 having the LEDs 13 thereon is prepared in advance, and the molding die 30 for molding the light guide plate 15 from resin is also prepared. As illustrated in FIGS. 4 and 5, the molding die 30 includes an upper die 31 and a lower die 32 that are closed and opened in the thickness direction (Z axis direction) of the light guide plate 15. The upper die 31 and the lower die 32 in a closed state define a molding space 33 for molding the light guide plate 15 therebetween. The LEDs 13 and the LED board 14 are inserted into the molding die 30 before formation of the light guide plate 15. The light emitting surfaces 13a and the mount surface 14a of the extension portion 20 face the molding space 33. Specifically described, as illustrated in FIG. 5, the upper die 31 of the molding die 30 has comb teeth 31a each shaped like a comb tooth in plan view. The comb teeth 31a overlap the LED non-overlapping portions 19 of the LED board 14 in plan view and are in contact with two side surfaces of the LED 13, which are adjacent to the light emitting surface 13a, the mounted surface 13b, and the mounted-surface opposite surface 13c. The comb teeth 31a are flush with the light emitting surfaces 13a of the LEDs 13a. This configuration allows, of the outer surfaces of the LEDs 13a, only the light emitting surfaces 13a to selectively face the molding space 33. As illustrated in FIG. 4, the lower die 32 of the molding die 30 has a groove 32a that houses the LED board 14. The depth of the groove 32a is substantially equal to the thickness of the LED board 14. This configuration allows, of the outer surfaces of the extension portion 20 of the LED board 14, only the mount surface 14a to selectively face the molding space 33.

To produce the light guide plate 15, first, the LEDs 13 and the LED board 14 are set in the lower die 32 of the molding die 30, and the upper die 31 is closed relative to the lower die 32. A resin material of the light guide plate 15 in a melted state is poured into the molding space 33 in the closed molding die 30, which is illustrated in FIGS. 4 and 5. At this time, the light emitting surfaces 13a of the LEDs 13 and the mount surface 14a of the extension portion 20 of the LED board 14, which face the molding space 33, come in direct contact with the resin material of the light guide plate 15. After the resin material of the light guide plate 15, which fills the molding space 33, is cooled and solidified, the molding die 30 is opened. The light guide plate 15 is produced in this way. The produced light guide plate 15 is fixed to the light emitting surfaces 13a with the light input surface 15 being in direct contact with the light emitting surfaces 13a of the LEDs 13 and is fixed to the mount surface 14a with a portion of the light-exit opposite surface 15c (end portion near the light input surface 15a) being in direct contact with the mount surface 14a of the extension portion 20 of the LED board 14. The above-described steps produce one-unit component integrally including the LEDs 13, the LED board 14, and the light guide plate 15.

As described above, the backlight device (lighting device) 12 of the embodiment includes the LED (light source) 13 having the light emitting surface 13a, the LED board (light source board) 14 having the mount surface 14a on which the LED 13 is mounted with the mounted surface 13b, which is one of outer surfaces of the LED 13 that is adjacent to the light emitting surface 13a, being in contact with the mount surface 14a, and the light guide plate 15 in which at least a portion of an outer end surface thereof is the light input surface 15a that receives light from the LED 13, one of two plate surfaces thereof is the light-exit surface 15b through which the light exits, and the other of the plate surfaces is the light-exit opposite surface 15c. The LED board 14 at least includes the LED overlapping portion (light-source overlapping portion) 18 overlapping the LED 13 and the extension portion 20 extending from the LED overlapping portion 18 in the direction in which the light emitting surface 13a faces. The light guide plate 15 is integrated with the LED 13 and the LED board 14 with the light input surface 15a being in direct contact with the light emitting surface 13a of the LED 13 and the light-exit opposite surface 15c being in direct contact with the mount surface 14a of the extension portion 20.

In this configuration, the outgoing light from the light emitting surface 13a of the LED 13 enters the light guide plate 15 through the light input surface 15a and the light that has traveled in the light guide plate 15 exits through the light-exit surface 15b. Since the light guide plate 15 is in direct contact with the light emitting surface 13a of the LED 13 at the light input surface 15a, input efficiency of light to the light input surface 15a is high. Furthermore, since the light guide plate 15 is integrated with the LEDs 13 and the LED board 14 while being in direct contact with the light emitting surfaces 13a of the LEDs 13, the positional relationship between the light input surface 15a and the light emitting surface 13a is unlikely to change when the light guide plate 15 is thermally expanded or contracted due to a change in temperature. This configuration advantageously allows the light input efficiency to remain high.

Furthermore, since the light guide plate 15 is integrated with the LEDs 13 and the LED board 14 with the light-exit opposite surface 15c thereof being in direct contact with the mount surface 14a of the extension portion 20, which is a portion of the LED board 14 extending from the LED overlapping portion 18 in a direction in which the light emitting surface 13a faces, the LED board 14 is not located in the light guide plate 15. This does not make the shape of the portion of the light guide plate 15 near the LEDs 13 complex and allows light to efficiently travel through the light guide plate 15. Furthermore, the light guide plate 15 is thin compared to the known light guide plate having the LED board therein. This makes the optical length of light traveling through the light guide plate 15 shorter, reducing the amount of light absorbed by the light guide plate 15. With this configuration, the amount of outgoing light from the light guide plate 15 through the light-exit surface 15b increases and the brightness of the outgoing light improves.

Furthermore, of the outer surfaces of the LED 13, the light guide plate 15 is selectively in direct contact with the light emitting surface 13a. In this configuration, the LEDs 13 are each in contact with the light guide plate 15 only at the light emitting surface 13a, which is one of outer surfaces of the LED 13, and thus heat generated by the LEDs 13 is less likely to be transferred to the light guide plate 15.

Furthermore, one of the light-exit surface 15b and the light-exit opposite surface 15c of the light guide plate 15 that is opposite the surface in contact with the extension portion 20 is flush with the mounted-surface opposite surface 13c of the LED 13, which is one of the outer surfaces opposite the mounted surface 13b in contact with the LED board 14. This configuration allows the input efficiency of light to the light input surface 15a to remain high and allows the thickness of the LED 13 to decrease up to the thickness of the light guide plate 15. Furthermore, in this configuration, the center of the LED 13 in the height direction matches the center of the light guide plate 15 in the thickness direction. This makes the input efficiency of light to the light input surface 15a very high.

Furthermore, the LED board 14 includes the circuit formation portion 21 extending from the LED overlapping portion 18 toward the side away from the extension portion 20 and having a circuit for applying current to the LEDs 13. In this configuration, the circuit formation portion 21, which extends from the LED overlapping portion 18 toward the side away from the extension portion 20, does not overlap the light guide plate 15. With this configuration, when the circuit is heated due to application of current to the LEDs 13, the heat is less likely to be transferred to the light guide plate 15.

Furthermore, the liquid crystal display device (display device) 10 according to the embodiment includes the above-described backlight device 12 and the liquid crystal panel (display panel) 11 configured to display an image by using light from the backlight device 12. The liquid crystal display device 10 having such a configuration has improved display quality and lower power consumption, because outgoing light from the backlight device 12 has improved brightness.

### Second Embodiment

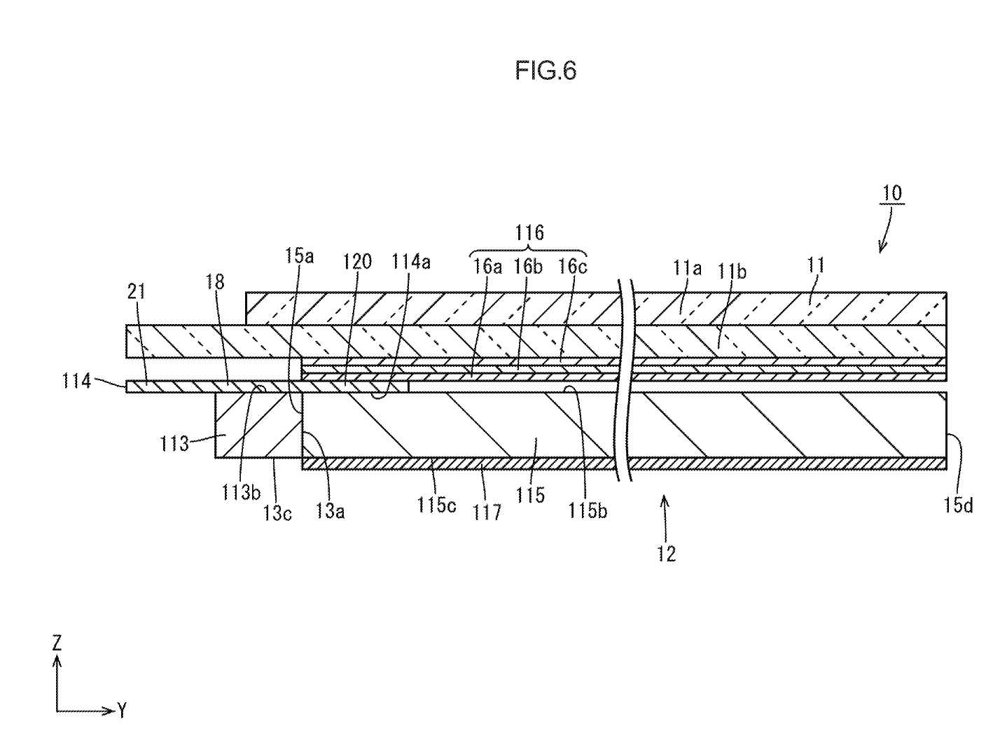

A second embodiment of the invention is described with reference to FIG. 6. In the second embodiment, the position of an LED board 114 relative to a light guide plate 115 is different. The structures, effects, and advantages substantially identical to those in the first embodiment are not described.

As illustrated in FIG. 6, an extension portion 120 of the LED board 114 according to the second embodiment is disposed on the front surface of the light guide plate 115. Specifically described, a rear plate surface of the LED board 114 is a mount surface 114a on which LEDs 113 are mounted. Thus, front surfaces of the LEDs 113 are mounted surfaces 113b that are in contact with the mount surface 114a of the LED board 114. The light guide plate 115 is fixed to the LED board 114 with the light-exit surface 115b, which is the front surface, being in direct contact with the mount surface 114a of the extension portion 120 of the LED board 114 without any other components therebetween. The effects and advantages substantially identical to those in the first embodiment are obtained by this configuration, furthermore, the LED board 114 in this embodiment is located between the light guide plate 115 and the optical sheet 116, and thus a space corresponding to the thickness of the LED board 114 is provided between the light guide plate 115 and the optical sheet 116. A reflection sheet 117 is disposed over the entire area of a light-exit opposite surface 115c of the light guide plate 115.

### Third Embodiment

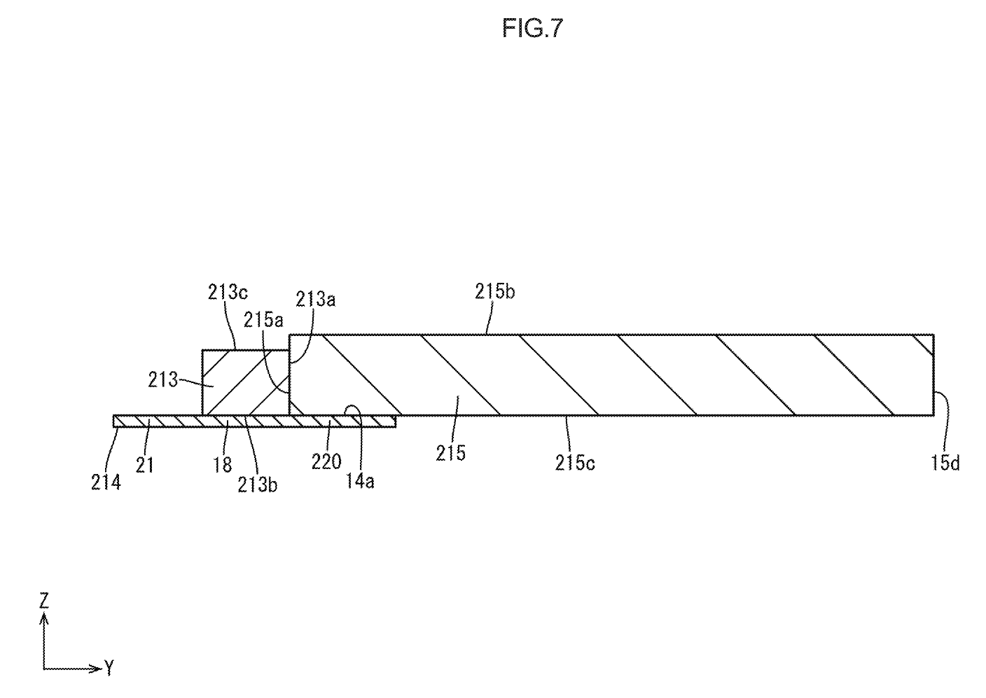

A third embodiment of the invention is described with reference to FIG. 7. In the third embodiment, a light guide plate 215 has a thickness different from that in the first embodiment. The configurations, effects, and advantages substantially identical to those in the first embodiment are not described.

As illustrated in FIG. 7, the light guide plate 215 according to the third embodiment has a thickness larger than the height of LEDs 213. A light-exit surface 215b of the light guide plate 215, which is a surface opposite a light-exit opposite surface 215c in contact with an extension portion 220 of an LED board 214, is located above a mounted-surface opposite surface 213c of the LED 213, which is an outer surface opposite a mounted surface 213b in contact with the LED board 214. In this configuration, a light input surface 215a of the light guide plate 215 faces the entire light emitting surface 213a of each LED 213, and thus the light input efficiency remains high.

### Other Embodiments

The present invention is not limited to the embodiments described above and illustrated by the drawings. For example, the following embodiments will be included in the technical scope of the present invention.

(1) According to the above embodiments, the LED board includes the circuit formation portion extending from the LED overlapping portion toward a side away from the extension portion. However, a circuit may be formed on the extension portion and the portion extending from the LED overlapping portion toward the side away from the extension portion may be eliminated.

(2) According to the above embodiments, the LEDs are connected in parallel through the circuit on the LED board. However, the LEDs may be connected in series through the circuit on the LED board, for example.

(3) According to the above embodiments, the molding die of the light guide plate is closed and opened in the Z axis direction. However, the molding die of the light guide plate may be closed and opened in the X axis direction or the Y axis direction. Furthermore, the specific configuration of the molding die (a parting line position, for example) may be suitably changed from that in the drawings.

(4) According to the above embodiments, of the outer surfaces of the LED, the light guide plate is selectively in direct contact with the light emitting surface. However, the light guide plate may be in direct contact with another outer surface (mounted-surface opposite surface, for example) of the LED in addition to the light emitting surface.

(5) According to the above embodiments, the light emitting surface of the LED is substantially flat. However, the light emitting surface of the LED may be curved.

(6) The specific number of LEDs on the LED board may be suitably changed from that in the above embodiments. Furthermore, the specific arrangement of the LEDs on the LED board may be suitably changed. In such a case, an irregular pitch arrangement in which some of the LEDs are arranged at a different interval may be employed.

(7) According to the above embodiments, the LED board (LEDs) is positioned such that an end surface of the light guide plate along one of the long sides becomes the light input surface. However, the LED board (LEDs) may be positioned such that an end surface of the light guide plate along one of the short sides becomes the light input surface.

(8) According to the above embodiments, the backlight device is a one-side edge-lit backlight device in which the LED board (LEDs) is positioned such that only one of four end surfaces of the light guide plate becomes a light input surface. However, the backlight device may be a two-side edge-lit backlight device in which two LED boards (LEDs) sandwich the light guide plate in the short side direction such that two of the four end surfaces of the light guide plate along the long sides become light input surfaces. Alternatively, the backlight device may be a two-side edge-lit backlight device in which two LED boards (LEDs) sandwich the light guide plate in the long-side direction such that two of the four end surfaces of the light guide plate along the short sides become light input surfaces.

(9) Other than the above (8), the LED board(s) (LEDs) may be positioned such that three end surfaces of the light guide plate become light input surfaces, or the LED board(s) (LEDs) may be positioned such that all four end surfaces of the light guide plate become light input surfaces.

(10) According to the above embodiments, one LED board is disposed relative to one side of the light guide plate. However, multiple LED boards may be disposed relative to one side of the light guide plate.

(11) According to the above embodiments, the light sources are LEDs. However, light sources other than LEDs (such as an organic EL) may be used.

(12) According to the above embodiments, the outer shape of the liquid crystal panel, the light guide plate, and the optical sheet, for example, is oblong. However, the outer shape of the liquid crystal panel, the light guide plate, and the optical sheet, for example, may be square, circle, ellipse, or other shapes.

(13) According to the above embodiments, the optical sheet includes three sheets. However, the optical sheet may include one, two, or four or more sheets. Furthermore, the order of laminations of the optical sheets and the kind of optical sheet, for example, may also be suitably changed.

(14) According to the above embodiments, the TFTs are used as the switching elements of the liquid crystal display device, but the present invention is also applicable to a liquid crystal display device that uses switching elements other than the TFTs (such as a thin film diode (TFD)). The present invention is also applicable to a black-and-white liquid crystal display device other than a color liquid crystal display device.

(15) According to the above embodiments, the liquid crystal display is a transmissive liquid crystal display device, but the present invention is also applicable to other liquid crystal display devices such as a semi-transmissive liquid crystal display device.

(16) According to the above embodiments, the liquid crystal display device includes a liquid crystal panel as a display panel. However, the present invention is also applicable to display devices including different kinds of display panel such as a microelectromechanical systems (MEMS) display panel.

(17) According to the above embodiments, the liquid crystal panel has a small size or a small to medium size. However, the present invention is also applicable to liquid crystal panels having a screen size of 20 inches to 100 inches, for example, which are categorized as a medium or large (very large) size. In such a case, the liquid crystal panel may be used in electronic devices such as a television receiver, an electronic signage (digital signage), and an electronic blackboard.

### EXPLANATION OF SYMBOLS

10 . . . liquid crystal display device (display device), 11 . . . liquid crystal panel (display panel), 12 . . . backlight device (lighting device), 13, 113, 213 . . . LED (light source), 13a, 213a . . . light emitting surface, 13b, 113b, 213b . . . mounted surface (surface in contact with light source board), 13c, 213c . . . mounted-surface opposite surface (opposite surface), 14, 114, 214 . . . LED board (light source board), 14a, 114a . . . mount surface, 15, 115, 215 . . . light guide plate, 15a, 215a . . . light input surface, 15b, 115b, 215b . . . light-exit surface, 15c, 115c, 215c . . . light-exit opposite surface, 18 . . . LED overlapping portion (light-source overlapping portion), 20, 120, 220 . . . extension portion, 21 . . . circuit formation portion

1. A lighting device comprising:
a light source having a light emitting surface;
a light source board having a mount surface on which the light source is mounted with one of outer surfaces of the light source that is adjacent to the light emitting surface being in contact with the mount surface, the light source board at least including a light-source overlapping portion overlapping the light source and an extension portion extending from the light-source overlapping portion in a direction in which the light emitting surface faces; and
a light guide plate in which at least a portion of an outer end surface thereof is a light input surface that receives light from the light source, one of two plate surfaces thereof is a light-exit surface through which the light exits, and the other of the plate surfaces is a light-exit opposite surface, the light guide plate being integrated with the light source and the light source board with the light input surface being in direct contact with the light emitting surface of the light source and the light-exit surface or the light-exit opposite surface being in direct contact with the mount surface of the extension portion.

2. The lighting device according to claim 1, wherein the light guide plate is selectively in direction contact with the light emitting surface, the light emitting surface being one of the outer surfaces of the light source.

3. The lighting device according to claim 1, wherein one of the light-exit surface and the light-exit opposite surface of the light guide plate that is opposite the surface in contact with the extension portion is flush with an outer surface of the light source opposite the outer surface in contact with the light source board.

4. The lighting device according to claim 1, wherein the light source board includes a circuit formation portion extending from the light-source overlapping portion toward a side away from the extension portion and having a circuit for applying current to the light source.

5. A display device comprising:
the lighting device according to claim 1; and
a display panel configured to display an image by using light from the lighting device.
